(19) United States
(12) Patent Application Publication
(10) Pub. No.: US 2008/0066098 A1
(43) Pub. Date: Mar. 13, 2008

(54) PHONE-BASED TARGETED ADVERTISEMENT DELIVERY

(75) Inventors: Bradley James Witteman, La Jolla, CA (US); Robert Reid, San Diego, CA (US)

Correspondence Address: FISH & RICHARDSON, PC, P.O. BOX 1022, MINNEAPOLIS, MN, 55440-1022, US

(73) Assignee: Skyclix, Inc.

(21) Appl. No.: 11/674,086

(22) Filed: Feb. 12, 2007

Related U.S. Application Data
(60) Provisional application No. 60/840,194, filed on Aug. 25, 2006.

(51) Int. Cl. H04N 7/10; H04N 7/025; H04N 7/16

(52) U.S. Cl. 725/34; 725/35; 725/135

(57) ABSTRACT

This specification describes technologies relating to a phone-based system for targeted advertisement delivery by identifying broadcast audio advertisements, and methods of providing such a system. In one aspect, a method includes receiving a user-initiated telephone connection that includes an audio sample of an advertisement from a broadcast source, and identifying the audio advertisement sample. The method also includes retrieving a metadata associated with the identified audio advertisement sample, obtaining a targeted advertisement information that most closely corresponds to the retrieved metadata. The method further includes transmitting a message including the targeted advertisement information. Other implementations of this aspect include corresponding systems, apparatus, and computer program products.

### PRIOR APPLICATIONS

This application claims priority to U.S. Application Ser. No. 60/840,194, filed on Aug. 25, 2006, the disclosure of which is incorporated by reference in its entirety. This application is also related to co-pending U.S. patent application Ser. No. 11/674,015, filed on Feb. 12, 2007 and entitled “Phone-based Broadcast Audio Identification,” the disclosure of which is incorporated in its entirety by reference.

### BACKGROUND

The subject matter described herein relates to a phone-based system for targeted advertisement delivery by identifying broadcast audio advertisements, and methods of providing such a system.

Companies spend billions of dollars every year in advertising to attract consumers to buy their products and services. While these advertisers can target a certain demographic sector of the population by associating the advertisements with certain programs, it is still difficult for the advertisers to deliver advertisements targeted to individual consumers. Text content based advertising is a well known technology on the Internet. There are well known methods of taking text information entered, e.g., by a user in a search engine, and searching for advertising based upon the text information or metadata associated with the text information. For example, when a user types in the words “digital camera” in the Google™ search engine and clicks on the “search” icon/hyperlink, various advertisements are displayed to attract the user's attention.

### SUMMARY

The present inventors recognized the deficiencies with conventional text-based advertisement identification and delivery systems, such as systems for text content advertising on the Internet. For example, it can be difficult for a conventional text-based system to identify an audio advertisement and deliver targeted advertisement information to a user based on the identified audio advertisement. Consequently, the present inventors developed the systems and methods described herein that provide flexibility, efficiency and scalability compared to conventional systems.

In one aspect, a method includes receiving a user-initiated telephone connection that includes an audio sample of an advertisement (audio advertisement sample) from a broadcast source, and identifying the audio advertisement sample. The method also includes retrieving a metadata associated with the identified audio advertisement sample, obtaining a targeted advertisement information that most closely corresponds to the retrieved metadata. The method further includes transmitting a message including the targeted advertisement information. Other implementations of this aspect include corresponding systems, apparatus, and computer program products.

In another aspect, a system includes a server, and a computer program product stored on one or more computer readable mediums, the computer program product including executable instructions configured to cause the server to perform operations that include receiving a user-initiated telephone connection comprising an audio advertisement sample from a broadcast source, and identifying the audio advertisement sample, retrieving a metadata associated with the identified audio advertisement sample, obtaining a targeted advertisement information that most closely corresponds to the retrieved metadata, and transmitting a message comprising the targeted advertisement information.

Variations may include one or more of the following features. For example, the act of identifying the audio advertisement sample can include obtaining a user audio watermark of the audio advertisement sample, comparing the user audio watermark with advertisement watermarks, and retrieving the advertisement watermark that most closely corresponds to the user audio watermark. The act of identifying the audio advertisement sample can also include generating a user audio fingerprint of the audio advertisement sample, associating a user audio timestamp with the user audio fingerprint, and retrieving telephone information through the user-initiated telephone connection. The act of identifying the audio advertisement sample can further include comparing the user audio fingerprint with advertisement fingerprints, and retrieving the advertisement fingerprint that most closely corresponds to the user audio fingerprint.

The act of identifying the audio advertisement sample can include generating text information based on the audio advertisement sample, comparing the generated text information with a database of advertisement text information, and retrieving the advertisement text information that most closely corresponds to the generated text information. The act of identifying the audio advertisement sample can also include associating a user timestamp with the user-initiated telephone connection, comparing the user timestamp with broadcast timestamps, and retrieving a broadcast timestamp that most closely corresponds to the user timestamp.

The act of identifying the audio advertisement sample can further include obtaining a preferred broadcast source based on a user preference, associating a user timestamp with the user-initiated telephone connection, comparing the user timestamp with broadcast timestamps associated with the preferred broadcast source, and retrieving a broadcast timestamp that most closely corresponds to the user timestamp.

The act of retrieving the metadata can include determining whether the audio advertisement sample contains the metadata, and generating the metadata, if the audio advertisement sample does not contain the metadata. The act of obtaining a targeted advertisement information can include comparing the metadata with advertisements in an advertisement inventory database, and obtaining an advertisement that most closely corresponds to the metadata.

The broadcast source can be one selected from a group of a radio station, a television station, an Internet website, an Internet service provider, a cable television station, a satellite radio station, a shopping mall, and a store. The message can be one selected from a group of a text message, an e-mail message, a multimedia message, an audio message, a wireless application protocol message, and a data feed. The metadata can be one selected from a group of a radio broadcast data standard (RBDS) broadcast stream, a radio data system (RDS) broadcast stream, a high definition radio broadcast stream, a vertical blanking interval (VBI) broadcast stream, a digital audio broadcasting (DAB) broadcast stream, a MediaFLO broadcast stream, and a closed caption broadcast stream. The telephone information can include at least one selected from a group of an automatic number identifier (ANI), a carrier identifier (Carrier ID), a dialed number identification service (DNIS), an automatic location identification (ALI), and a base station number (BSN).

Computer program products, which may be embodied on computer readable-material, are also described. Such computer program products can include executable instructions that cause a computer system to conduct one or more of the method acts described herein. Similarly, computer systems are also described that can include one or more processors and a memory coupled to the one or more processors. The memory can encode one or more programs that cause the one or more processors to perform one or more of the method acts described herein. These general and specific aspects can be implemented using a system, a method, or a computer program, or any combination of systems, methods, and computer programs.

The systems and methods described herein can, e.g., cache broadcast audio streams including advertisements in real-time and retrieve the broadcast information (e.g., metadata, RBDS and HD Radio information), if any, associated with the cached broadcast audio advertisements. Further, the system can, e.g., identify what station or channel and what kind of advertisements a user is listening to by comparing an audio advertisement sample taken of a live broadcast advertisement provided by the user through his phone (e.g., a mobile or land-line phone) with the cached broadcast advertisements and retrieving broadcast advertisement identification information from the cache. Additionally, the system can, e.g., compare the advertisement identification information with an advertisement targeting database and deliver an interactive and targeted advertisement to the user's phone.

The systems and methods described herein can provide one or more of the following advantages. For example, they offer the ability to identify broadcast audio advertisement from any broadcast source, and facilitate scalable deployment in geographic regions having different broadcast markets or different spoken languages. Additionally, the systems and methods described herein can allow a user to directly interact with an audio advertisement by identifying broadcast audio advertisements from a variety of broadcast sources, such as terrestrial broadcast sources, cable broadcast sources, satellite broadcast sources, or Internet broadcast sources, or any other broadcast source known to one of skill.

Moreover, the systems and methods described herein can enable other business models based on a catalog of the broadcast information identified from the broadcast audio advertisement. Also, the systems and methods do not depend on deployment of equipment at any broadcast source because servers can be tuned into the broadcast audio advertisements in a particular geographic region. In this manner, the systems and methods can be flexible and scalable because it does not rely on the broadcasters' modifying their business processes.

Other aspects, features, and advantages will become apparent from the following detailed description, the drawings, and the claims.

### BRIEF DESCRIPTION OF THE DRAWINGS

FIG. 1 is a conceptual diagram of a system that can analyze audio advertisement samples obtained from a live broadcast and deliver targeted, interactive advertisement messages to the user.

FIG. 2 illustrates a schematic diagram of a system that can identify broadcast audio advertisements from various broadcast sources in a geographic region.

FIG. 3 is a flow chart showing a method for delivering targeted advertisements to a user's phone.

FIG. 4A shows an example of a wireless access protocol (WAP) message that can be displayed on a user's phone to allow a user to rate the audio broadcast sample and contact the advertiser.

FIG. 4B shows another example of a WAP message that can be displayed on a user's phone to allow a user to visit the advertiser's website or download a rebate form.

FIG. 4C shows yet another example of a WAP message including a coupon that can be displayed on a user's phone and used by the user in a future transaction.

FIG. 5 is a flow chart showing a method for providing broadcast advertisement identification.

Like reference symbols in the various drawings indicate like elements.

### DETAILED DESCRIPTION

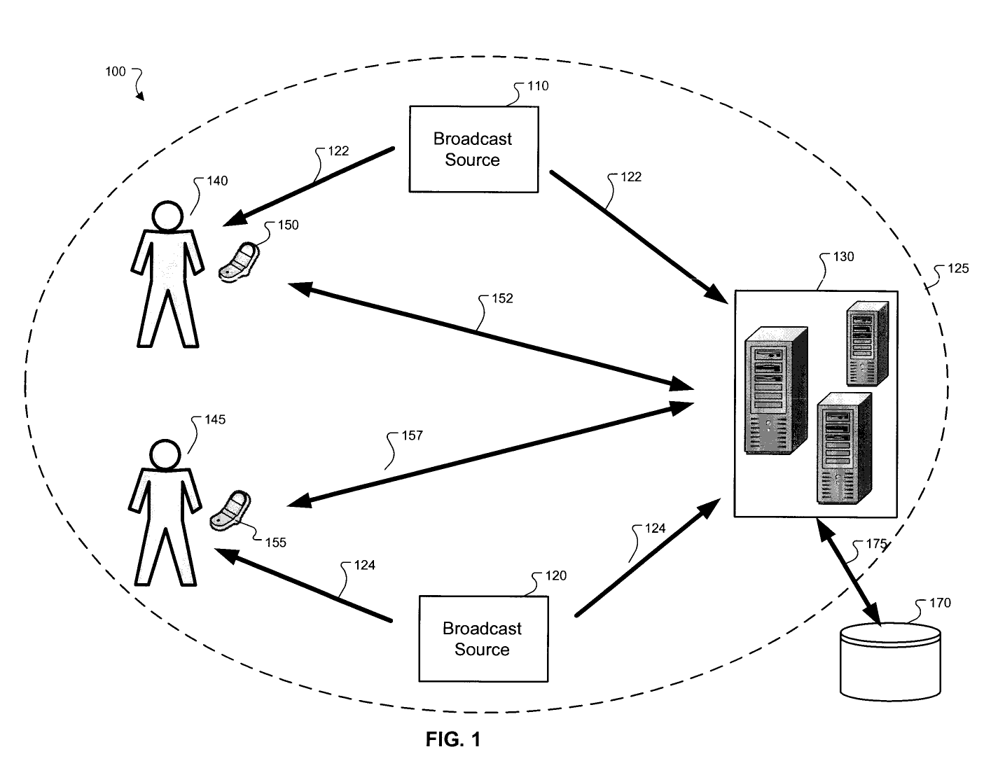

FIG. 1 is a conceptual diagram of a system 100 that can analyze audio advertisement samples obtained from a live broadcast, such as broadcast stream 122, from a broadcast audio source, e.g., 110, via a user's phone, e.g., 150, and deliver via a communication link, e.g., 152, targeted, interactive advertisement messages to the user's phone, e.g., 150. The system and its associated methods permit users to receive targeted advertisement information associated with broadcast audio advertisements that are both current and relevant. It is current because it reflects real-time broadcast advertisements. It is relevant because it can provide interactive information that are of interest to the user, such as hyperlinks to the stores and coupons, based on the audio advertisement sample without requiring the user to recognize or enter detailed information about the live broadcast advertisements from which the audio advertisement sample is taken.

In a given geographic region (e.g., a metropolitan area, a town, or a city), there can be various broadcast audio sources 110, 120, such as radio stations, television stations, satellite radio and television stations, cable companies and the like. Each broadcast audio source 110, 120 can transmit one or more audio broadcast streams 122, 124 that include broadcast audio advertisement (or broadcast advertisement), and some broadcast audio sources 110, 120 can also provide video streams (not shown). A broadcast audio stream (or broadcast stream) 122, 124 includes an audio component (broadcast audio) and a data component (metadata), which describes the content of the audio advertisement. Similarly, a broadcast advertisement has an audio component and can also include a data component (metadata). As shown in FIG. 1, broadcast sources 110, 120 each transmits a corresponding broadcast stream that includes broadcast advertisement 122, 124 in a geographic region 125. A server cluster 130, which can include multiple servers in a distributed system or a single server, performs the broadcast advertisement identification and delivers targeted advertisements to the users 140, 145.

The server cluster 130 can be deployed in situ or remotely from the broadcast sources 110, 120. In the case of a remote deployment, the server cluster 130 can receive the broadcast streams 122, 124 in real time by tuning to the broadcast sources 110, 120. Additionally, the server cluster can receive feeds of the broadcast streams 122, 124 including the broadcast advertisements and their associated metadata from the broadcast sources 110, 120. In the case of an in situ deployment, a server of the server cluster 130 is deployed in each of the broadcast sources 110, 120 to receive the broadcast streams 122, 124 in real time, as each broadcast stream 122, 124 is transmitted. Moreover, the server cluster 130 can also be implemented by just one broadcast source 110, 120 and a content management system can be maintained for the broadcast stream including all the broadcast advertisements being transmitted by the broadcast source.

Users, e.g., users 140, 145, who are tuned to particular broadcast channels of the broadcast sources 110, 120 may want more information on the broadcast advertisement that they are listening to or just heard. As an example, user 140 may be listening to an advertisement on broadcast stream 122 being transmitted from the broadcast source 110. If the user 140 likes the products or services mentioned in the advertisement but does not recognize the advertiser (e.g., because the product or service is new) and would like to obtain more information, the user 140 can then use his phone 150 to connect with the server cluster 130 via a communications link 152 and obtain information associated with the advertisement. The communications link 152 can be a cellular network, a wireless network, a satellite network, an Internet network, some other type of communications network or combination of these. The phone 150 can be a mobile phone, a traditional landline-based telephone, or an accessory device to one of these types of phones.

By using the phone 150, the user 140 can relay the broadcast advertisement via the communications link 152 to the server cluster 130. A server in the server cluster 130, e.g., an audio server, samples the broadcast advertisement relayed to it from the phone 150 via communications link 152 for a predefined period of time, e.g., about 20 seconds in this implementation, and caches (i.e., stores temporarily in a non-persistent manner) the sample (i.e., audio advertisement sample). In other implementations, the predefined period of time can be more or less than 20 seconds depending on design constraints. For example, the predefined period of time can be 5 seconds, 10 seconds, 24 seconds, or some other period of time.

The server cluster 130 can then perform an audio advertisement identification by comparing the broadcast sample with a broadcast advertisement identification system. In one implementation, the identification system is a database of broadcast advertisements with watermarks (unique markers) inserted in the advertisements. In another implementation, the identification system is a cache or a database library of broadcast advertisement fingerprints. The system 100 can be configured to communicate with one or more of these broadcast advertisement identification systems in order to identify the audio advertisement sample.

Once an identification of the broadcast advertisement has been achieved, the server cluster 130 can then forward the metadata associated with the identified advertisement to an advertisement targeting server 170 via communications link 175. The advertisement targeting server searches through its database of advertisements and selects an advertisement (targeted advertisement) that most closely corresponds to the metadata. The targeted advertisement is then sent to the server cluster 130 through communications link 175, which delivers a targeted and interactive advertisement message to the user 140 via communications link 152.

The targeted advertisement message can include the content of the advertisement, as well as a hyperlink to the advertiser's website or a hyperlink to download a coupon associated with the targeted advertisement. Alternatively, the message can be a text message (e.g., SMS), a video message, an audio message, a multimedia message (e.g., MMS), a wireless application protocol (WAP) message, a data feed (e.g., an RSS feed, XML feed, etc.), or a combination of these, or any other type of message known to one of skill. Additionally, the targeted advertisement message can include advertisement that are disassociated from, but related to, the identified advertisement metadata. As an example, the identified advertisement metadata can be used to perform a search on relevant advertisement information. Thus, for example, when the identified advertisement metadata contains information about McDonald's, the targeted advertisement message can include an advertisement for other burger places, such as Burger King.

Similarly, the user 145 may be listening to the broadcast stream 124 being transmitted by the broadcast source 120 and wants to find out more about a special discount for a trip to Hawaii that is being discussed. The user 145 can then use her phone 155, which can be a mobile phone, a traditional landline-based telephone, or an accessory device to one of these types of phones, to connect with the server cluster 130 via communications link 157 and obtain more information. By using the phone 155, the user 145 can relay the broadcast advertisement via the communications link 157 to the server cluster 130. A server in the server cluster 130, e.g., an audio server, samples the broadcast advertisement relayed to it from the phone 155 via communications link 157 for a predefined period of time, e.g., about 20 seconds in this implementation, and stores the sample (i.e., audio advertisement sample). Again, in other implementations, the predefined period of time can be more or less than 20 seconds depending on design constraints. For example, the predefined period of time can be about 5 seconds, 10 seconds, 14 seconds, 24 seconds, or some other period of time.

As noted above, the targeted advertisement message can be in a form of a WAP message, which can include, e.g., a hyperlink to the broadcast source (e.g., the radio station) to obtain the rules of the discount price. Furthermore, the message can be delivered to the user via SMS, MMS (which can include a coupon), or email, or the message can be delivered to the user's stored history on an Internet site. Additionally, the message can allow the user 145 to “scroll” back to an earlier segment of the broadcast by a predetermined amount of time, e.g., 30 seconds or some other period of time, in order to obtain information on broadcast audio that she might have missed. This feature in the interactive message can accommodate situations where the user just heard a couple of seconds of the special discount, and by the time she dials-in or connects to the system 100, the discount info is no longer being transmitted.

In addition to the server cluster 130 (which is associated with the geographic region 125), other server clusters can be deployed to service other geographic regions. A superset of server clusters can be formed with each server cluster communicatively coupled to one another. Thus, when one server cluster in a particular geographic region cannot identify an audio broadcast sample taken from a broadcast stream that was relayed by a user via his phone, server clusters in neighboring geographic regions can be queried to perform the broadcast advertisement identification. Therefore, the system 100 can allow for situations where a user travels from one geographic region to another geographic region.

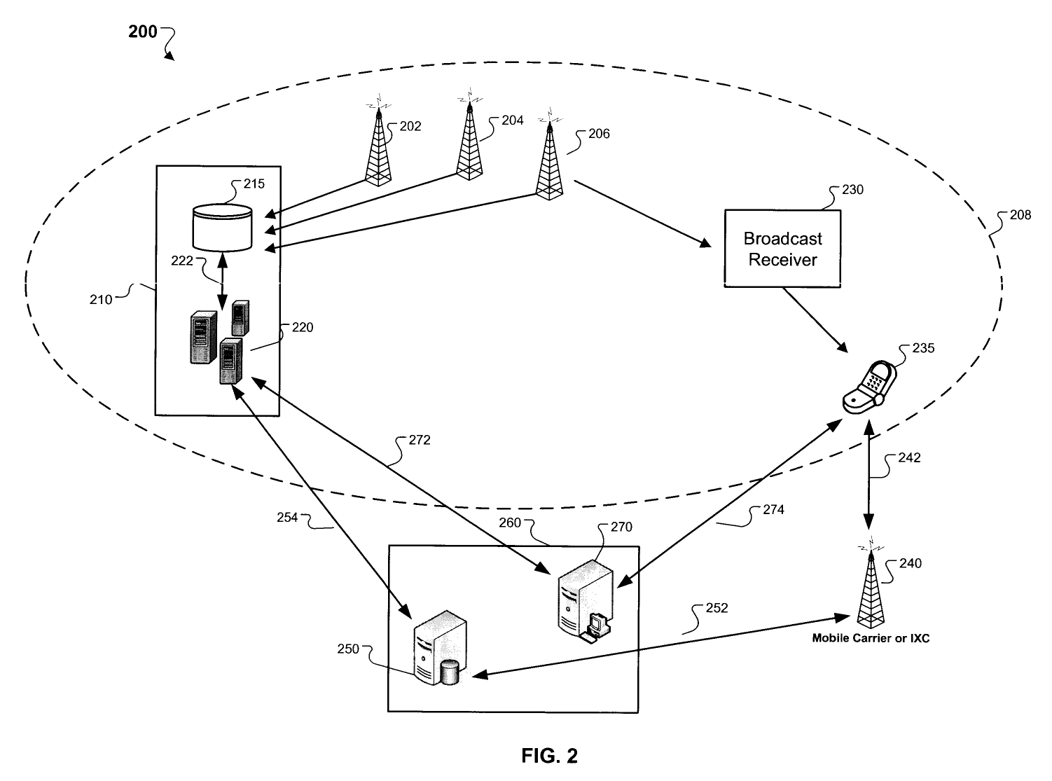

FIG. 2 illustrates a schematic diagram of a system 200 that can be used to identify broadcast advertisements from various broadcast sources 202, 204, and 206 in a geographic region 208. The broadcast sources 202, 204, and 206 can be any type of source, such as a radio, a television, an Internet site, a satellite, and a location broadcast (e.g., background music at a mall), capable of transmitting broadcast streams that include broadcast advertisements. A server cluster 210, which includes a capture server 215 and a broadcast server 220, can be deployed in the geographic region 208 to record broadcast streams and deliver targeted advertisement messages to users. In one implementation, the capture server 215 can be deployed remote from the broadcast sources 202, 204, and 206 and broadcast server 220, but still within the geographic region 208; on the other hand, the broadcast server 220 can be deployed outside of the geographic region 208, but communicatively coupled with the capture server 215 via a communications link 222.

The capture server 215 receives and caches the broadcast streams. Once the capture sever 210 has cached broadcast streams for a non-persistent, selected temporary period of time, the capture server 215 starts overwriting the previously cached broadcast streams in a first-in-first-out (FIFO) fashion. In this manner, the capture server 210 is different from a database library, which stores pre-processed information and intends to store information permanently for long periods of time. Further, the most recent broadcast streams for the selected temporary period of time will be cached in the capture server 215. In one implementation, the selected temporary period of time can be configured to be about fifteen minutes and the capture server 210 caches the latest 15-minute duration of broadcast streams in the geographic region 208. In other implementations, the selected temporary period of time can be configured to be longer or shorter than 15 minutes, e.g., five minutes, 45 minutes, 3 hours, a day, or a month.

The cached broadcast streams can then be processed by the broadcast server 220 to generate a series of broadcast fingerprints, which is discussed in further detail below. Each of these broadcast fingerprints is associated with a broadcast timestamp, which indicates the time that the broadcast stream was cached in the capture server 215. The broadcast server 220 can also generate broadcast stream audio identifiers (BSAIs) associated with the cached broadcast streams. Each BSAI corresponds to a predetermined portion or segment (e.g., 20 seconds) of a broadcast stream, and can include the broadcast fingerprint, the broadcast timestamp and metadata (broadcast information) retrieved from the broadcast stream. The BSAIs are cached in the broadcast server 220 and can facilitate searching of an audio match generated from another source of audio.

A broadcast receiver 230 can be tuned by a user to one of the broadcast sources 202, 204, and 206. The broadcast receiver 230 can be any device capable of receiving broadcast audio, such as a radio, a television, a stereo receiver, a cable box, a computer, a digital video recorder, or a satellite radio receiver. As an example, suppose the broadcast receiver 230 is tuned to the broadcast source 206. A user listening to broadcast source 206 can then use her phone 235 to connect with the system 200, by, e.g., dialing a number (e.g., a local number, a toll free number, a vertical short code, or a short code), or clicking a link or icon on the phone's display, or issuing a voice or audio command. The user, via the user's phone 235, is then connected to a network carrier 240, such as a mobile phone carrier, an interexchange carrier (IXC), or some other network, through communications link 242.

After receiving connection from the user's phone 235, the phone carrier 240 then connects to the audio server 250, which is a part of the network operations center (NOC) 260, through communications link 252. The audio server 250 can obtain certain telephone information of the connection based on, e.g., the signaling system #7 (SS7) protocol, which is discussed in detail below. The audio server 250 can also sample the broadcast stream relayed by the user via the phone 235, cache the audio advertisement sample, and generate a user audio identifier (UAI) based on the cached audio advertisement sample. The audio server 250 then forwards the UAI to the broadcast server 220 via communications link 254 for an audio advertisement identification by performing a comparison between the UAI and a pool of cached BSAIs. The most highly correlated BSAI is then used to provide targeted advertisement to the user. Details of this comparison can be found in the related co-pending U.S. application Ser. No. 11/674,015, entitled “Phone-based Broadcast Audio Identification.”

The broadcast server 220 then sends relevant metadata based on the identified BSAI to the commerce server 270, which is also a part of the NOC 260, via a communications link 272. The commerce server 270 can include an advertisement targeting database (not shown), which stores a pool of advertisements from various advertisers. In another implementation, the advertisement targeting database can be deployed remotely from the NOC 260 or implemented by a third-party. The commerce server 270 compares the metadata of the identified audio advertisement sample with the pool of targeting advertisements to find the advertisement that most highly corresponds to the metadata.

A user data set, which can include the targeted advertisement, the user timestamp, and user data (if any), is sent to the commerce server 270. The commerce server 270 can take the received user data set and generate an interactive and targeted advertisement message, e.g., a text message, a multimedia message, or a WAP message. In addition to the user data set, other information, such as coupons, online shopping sites, nearby brick-and-mortar shopping sites, and instant advertiser feedback can be included in the message. This interactive and targeted advertisement message can be transmitted via a communications link 274 to the user's phone 235 by various means, such as SMS, MMS, e-mail, instant message, text-to-speech through a telephone call, and voice-over-Internet-protocol (VoIP) call, or a data feed (e.g., an RSS feed or XML feed). Upon receiving the message from the commerce server 270, a user can, e.g., request more information or purchase the product mentioned in the advertisement, e.g., by clicking on an embedded hyperlink.

In one implementation, the audio server 250 includes telephony line cards interfaced with the network carrier 240. In another implementation, the audio server 250 is outsourced to an IXC which can process audio samples, generate UAIs and relay the UAIs back to the NOC over a network connection. The audio server 250 can also include a user database that stores the user history and preference settings, which can be used to generate personalized messages to the user. The audio server 250 also includes a queuing system for sending UAIs to the broadcast server 220, a backup database of content audio fingerprints sourced from a third party, and a heartbeat and management tool to report on the status of the server cluster 210 and BSAI generation. The commerce server 270 can include an SMTP mail relay for sending SMS messages to the user's phone 225, an Apache web server (or the like) for generating WAP sessions, an interface to other web sites for commerce resolutions, and an interface to the audio server 250 to file user identification events to a database of user profiles.

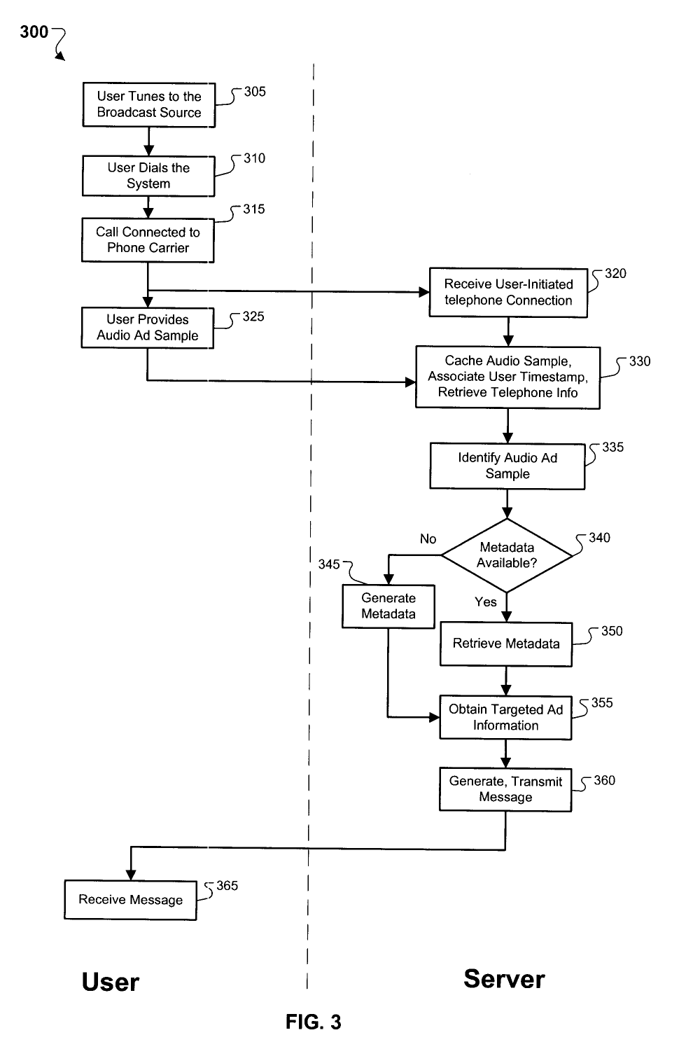

FIG. 3 is a flow chart showing a method 300 for providing targeted advertisement based on an audio advertisement sample in a broadcast stream provided by a user through a user-initiated connection, such as by dialing a phone number. At 305, a user tunes to a broadcast source to receive one or more broadcast audio streams that include broadcast advertisements. This broadcast source can be a pre-set radio station that the user likes to listen to or it can be a television station that she just tuned in. Alternatively, the broadcast source can be a location broadcast that provides background music in a public area, such as a store or a shopping mall.

The broadcast stream can be an audio channel transmitted from a particular broadcast source in a geographic region. For example, the geographic region can be the San Diego metropolitan area, the broadcast source can be radio station KMYI, and the audio channel can be 94.1 FM. The broadcast stream can include an audio signal, which is the audio component of the broadcast, and metadata, which is the data component of the broadcast. Additionally, the broadcast stream can include an audio chime that alerts a listener to the broadcast advertisement. For example, the audio chime can be a 5-second long musical chime that users can associate with the targeted advertisement delivery system described herein. Thus, when a user hears the audio chime, the user knows that the following broadcast segment has targeted advertisement enabled.

At 310, the user uses a telephone (e.g., mobile phone or a landline-based phone) to connect to the server by, e.g., dialing a number, a short code, and the like. At 315, the call is connected to a carrier, which can be a mobile phone carrier or an IXC carrier. The carrier can then open a connection with the server, at 320 the server receives the user-initiated telephone connection. At 325, the user is connected to the server and an audio advertisement sample can be relayed by the user to the server.

At 320, the server receives the user-initiated telephone connection and, at 330, the server caches the audio advertisement sample, associates a user audio timestamp with the cached audio advertisement sample, and retrieves telephone information by, e.g., the SS7 protocol. The SS7 information can include the following elements: (1) an automatic number identifier (ANI, or Caller ID); (2) a carrier identification (Carrier ID) that identifies which carrier originated the call. If this is unavailable, and the user has not identified her carrier in her user profile, a local number portability (LNP) database can be used to ascertain the home carrier of the caller for messaging purposes. For example, suppose that the user's phone number is 123-456-2222, if the LNP is queried, it would say it “belongs” to T-Mobile USA. In this manner, a lookup table can be searched and an email address can be concatenated (e.g., 1234562222@tmomail.net) together and a message can be sent to that email address. This can also allow the server to know if the user is calling from a land line telephone (non-mobile) and take separate action (like sending it to an e-mail, or simply just logging it in the user's history; (3) a dialed number identification service (DNIS) that identifies what digits the user dialed (used, e.g., for segmentation of the service); (4) an automatic location identification (ALI, part of E911) or a base station number (BSN) that is associated with a specific cellular tower or a small collection of geographically bordering cellular towers. The ALI or BSN information can be used to identify what server cluster the user is located in and what pool of BSAI cache the UAI should be compared with. Additionally, the ALI or BSN information can be used to obtain an approximate location of the user and provide location-based advertisements to the user.

In one implementation, the server assigns the user timestamp based on the time that the audio advertisement sample is cached by the server. The audio advertisement sample is a portion of the broadcast advertisement that the user is interested in and the portion can be a predetermine period of time, for example, a 5-20 second long audio stream. At 335, the server identifies the audio advertisement sample using various identification systems and methods, which are discussed in detail below.

At 340, the server determines whether metadata is available for the identified audio advertisement sample. At 345, if there is no metadata available from the audio advertisement sample, the server generates a metadata by querying an alternate database, such as the electronic programming guide, broadcaster real-time data feed, and the like. At 350 if there is metadata available from the audio advertisement sample, the server retrieves the metadata. As discussed above, the metadata can be retrieved from the data component of the broadcast advertisement. The metadata can be obtained from various broadcast formats or standards, such as a radio data system (RDS), a radio broadcast data system (RBDS), a hybrid digital (HD) radio system, a vertical blank interval (VBI) format, a closed caption format, a MediaFLO format, or a text format. At 355, using the retrieved metadata 350 or the generated metadata 345, the server can obtain targeted advertisement information by querying an advertisement targeting database. At 360, the server generates a message, which can be a text message (e.g., an SMS message), a multimedia message (e.g., a MMS message), an email message, or a wireless application protocol (WAP) message. This message is transmitted to the user's phone and received by the user at 365.

The amount of data and the format of the message sent by the server depends on the user's phone capability. For example, if the phone is a smartphone with Internet access, then a WAP message can be sent with embedded hyperlinks to allow the user to obtain additional information, such as a link to the advertiser's website, a link to an online store to purchase the product or services, and the like. The WAP message can offer other interactive information based on ALI or BSN and user profile. For example, addresses of nearby stores offering the products or services and hyperlinks to maps of those nearby stores can be included. On the other hand, if the phone is a traditional landline-based telephone, the server may only send an audio message with audio prompts.

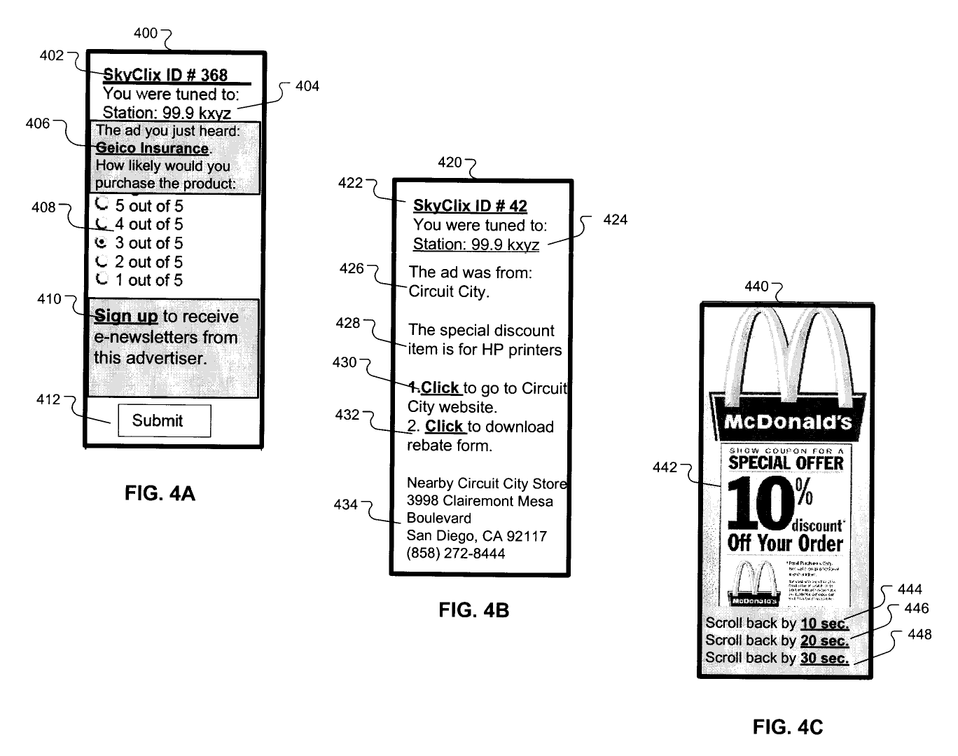

FIGS. 4A-4C illustrate exemplary targeted advertisement messages that a server can send to a user based on the identified broadcast advertisement sample. FIG. 4A shows an example of a WAP message 400 that allows the user to rate the audio advertisement sample and contact the advertiser. For example, the WAP message 400 includes a message ID 402 and identifies the broadcast source as radio station KXYZ 404. The WAP message 400 also identifies the advertiser 406 as “Geico Insurance.” Additionally, the user can enter a rating 408 of how likely she would purchase the product from the advertiser or sign up 410 to receive monthly electronic newsletter from the advertiser by clicking the “Submit” button 412.

FIG. 4B shows an example of a WAP message 420 that allows the user to purchase the identified product in the advertisement or download a rebate form. For example, the WAP message 420 includes a message ID 422 and identifies the broadcast sources as radio station KXYZ 424. The WAP message 420 also identifies the advertiser 426 as “Circuit City,” and the advertised product 428 as “HP Printers.” Additionally, the user can visit the advertiser's website by clicking on the hyperlink 430 or download a rebate form by clicking on the hyperlink 432. Furthermore, WAP message 420 includes an the address 434 of a nearby store associated with the advertiser.

FIG. 4C shows an example of a WAP message 440 that delivers a coupon to the user's phone. For example, the WAP message 440 includes a 10% discount coupon 442 for “McDonald's.” In this example, the audio advertisement sample provided by the user is an advertisement or a jingle by “McDonald's” and as the server identifies the advertisement by retrieving the metadata associated with the advertisement, the server can generate a WAP message that is targeted to interested users.

Additionally, the WAP message 440 can include a “scroll back” feature to allow the user to obtain information on a previous segment of the broadcast stream that she might have missed. For example, the WAP message 440 includes a hyperlink 444 to allow the user to scroll back to a previous segment by 10 seconds, a hyperlink 446 to allow the user to scroll back to a previous segment by 20 seconds, a hyperlink 448 to allow the user to scroll back to a previous segment by 30 seconds. Other predetermined period of time can also be provided by the WAP message 440, as long as that segment of the broadcast stream is still cached in the server. This “scroll back” feature can accommodate situations where the user just heard a couple of seconds of the broadcast stream, and by the time she dials-in or connects to the broadcast audio identification system, the broadcast info is no longer being transmitted.

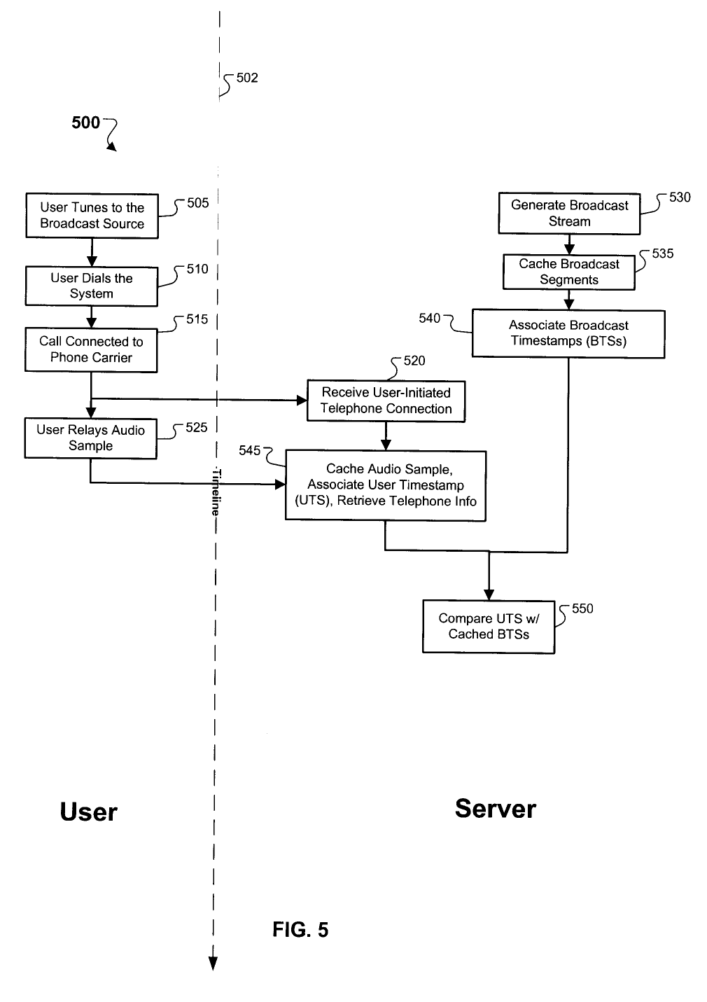

FIG. 5 is a flow chart showing a method 500 for providing broadcast advertisement identification based on audio advertisement samples obtained from a broadcast stream provided by a user through a user-initiated connection, such as by dialing a number. The method can be implemented, e.g., by a broadcast source. In this case, there is one broadcast stream to be identified and the broadcast source already has information on the advertisements included in the broadcast stream being transmitted. The steps of method 500 are shown in reference to a timeline 502; thus, two steps that are at the same vertical position along timeline 502 indicates that the steps can be performed at substantially the same time. In other implementations, the steps of method 500 can be performed in different order and/or at different times.

In this implementation, however, at 505, a user tunes to a broadcast source to receive a broadcast audio stream included broadcast advertisement transmitted by the broadcast source. This broadcast source can be a pre-set radio station that the user likes to listen to or it can be a television station that she just tuned in. Alternatively, the broadcast source can be a location broadcast that provides background music in a public area, such as a store or a shopping mall.

At 510, the user uses a telephone (e.g., mobile phone or a landline-based phone) to connect to the server of the broadcast source by, e.g., dialing a number, a short code, and the like. Additionally, the user can dial a number assigned to the broadcast source; for example, if the broadcast source is a radio station transmitting at 94.1 FM, the user can simply dial “*941” to connect to the server. At 515, the call is connected to a carrier, which can be a mobile phone carrier or an IXC carrier. The carrier can then open a connection with the server, at 520 the server receives the user-initiated telephone connection. At 525, the user is connected to the server and an audio sample can be relayed by the user to the server.

While the user is tuning to the broadcast source, at 530, the server can be generating the broadcast stream including the advertisement to be transmitted by the broadcast source. In another implementation, instead of generating the broadcast stream, the server can simply obtain the broadcast stream including the advertisements, such as where the server is not part of the broadcast source's system. The broadcast stream can include many broadcast segments, each segment being a predetermined portion of the broadcast stream. For example, a broadcast segment can be a 5-second, 10-second, 20-second, or any other time duration of the broadcast stream. The broadcast stream can also include an audio signal, which is the audio component of the broadcast, and metadata, which is the data component of the broadcast. The metadata can be obtained from various broadcast formats or standards, such as those discussed above.

At 535, the generated broadcast segments are cached for a selected temporary period of time, for example, about 15 minutes. At 540, a broadcast timestamp (BTS) is associated with each of the cached broadcast segment. At 520, the server receives the user-initiated telephone connection and, at 845, the server caches the audio advertisement sample, associates a user timestamp (UTS) with the cached audio advertisement sample, and retrieves telephone information by, e.g., the SS7 protocol. In one implementation, the server assigns the user timestamp based on the time that the audio advertisement sample is cached by the server. The audio advertisement sample is a portion of the broadcast advertisement that the user may be interested in and the portion can be a predetermine period of time, for example, a 5-20 second long audio stream. The duration of the audio advertisement sample can be configured so that it corresponds with the duration of the broadcast segment of the broadcast stream. At 550, the server compares the UTS with the cached BTSs to find the most highly correlated BTS. Once the highest correlated BTS is selected, its associated broadcast segment can be retrieved. Thus, the broadcast advertisement can be identified simply by using the user timestamp.

As noted above, the targeted advertisement delivery system can utilize any available methods of identifying a audio advertisement sample provided by a user through a user-initiated telephone connection. In one implementation, the audio advertisement sample identification can be achieved by comparing with a database of watermarked advertisements, which have unique markers embedded within the advertisements. In another implementation, the audio advertisement sample identification can be achieved by comparing with a database or cache of fingerprinted advertisements. Details of an identification system using a cache of broadcast fingerprints can be found in the related co-pending U.S. application Ser. No. 11/674,015, entitled “Phone-based Broadcast Audio Identification.”

In another implementation, the audio advertisement sample identification can be achieved by converting audio advertisement samples into text information using a speech to text converter and then comparing the converted text information with a database of text-based advertisement information. In yet another implementation, the audio advertisement sample identification can be achieved by associating a user timestamp with a user-initiated telephone connection, and then comparing the user timestamp with broadcast timestamps for a broadcast source.

In another implementation, the audio advertisement sample identification can be achieved by obtaining a preferred broadcast source from a user based on the user-specified preference. For example, a user may only listen to one particular radio station, and she can configure her user profile in a way that only the broadcast advertisement from such radio station is selected for identification. The identification method can then include associating a user timestamp with the user-initiated telephone connection, comparing the user timestamp with broadcast timestamps this preferred radio station, and retrieving a broadcast timestamp that most closely corresponds to the user timestamp. Since only broadcast advertisement from the preferred radio station is selected for comparison, the retrieved broadcast timestamp can indicate what information was transmitted by the radio station at that particular time corresponding to the broadcast timestamp.

Various implementations of the subject matter described herein can be realized in digital electronic circuitry, integrated circuitry, specially designed ASICs (application specific integrated circuits), computer hardware, firmware, software, and/or combinations thereof. These various implementations can include implementations in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “memory” comprises a “computer-readable medium” that includes any computer program product, apparatus and/or device (e.g., magnetic discs, optical disks, RAM, ROM, registers, cache, flash memory, and Programmable, Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

While many specifics implementations have been described, these should not be construed as limitations on the scope of the subject matter described herein or of what may be claimed, but rather as descriptions of features specific to particular implementations. Certain features that are described herein in the context of separate implementations can also be implemented in combination in a single implementation. Conversely, various features, that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations or steps are depicted in the drawings in a particular order, this should not be understood as requiring that such operations or steps be performed in the particular order shown or in sequential order, or that all illustrated operations or steps be performed, to achieve desirable results. In certain circumstances, multitasking and parallel processing may be advantageous. Moreover, the separation of various system components in the implementations described above should not be understood as requiring such separation in all implementations.

Although a few variations have been described in detail above, other modifications are possible. Accordingly, other implementations are within the scope of the following claims. For example, the actions recited in the claims can be performed in a different order and still achieve desirable results.

What is claimed is:

1. A method comprising:
receiving a user-initiated telephone connection comprising an audio advertisement sample from a broadcast source;
identifying the audio advertisement sample;
retrieving a metadata associated with the identified audio advertisement sample;
obtaining a targeted advertisement information that most closely corresponds to the retrieved metadata; and
transmitting a message comprising the targeted advertisement information.

2. The method of claim 1, wherein identifying the audio advertisement sample comprises:
obtaining a user audio watermark of the audio advertisement sample;
comparing the user audio watermark with a plurality of advertisement watermarks; and
retrieving the advertisement watermark that most closely corresponds to the user audio watermark.

3. The method of claim 1, wherein identifying the audio advertisement sample comprises:
generating a user audio fingerprint of the audio advertisement sample;
associating a user audio timestamp with the user audio fingerprint; and
retrieving telephone information through the user-initiated telephone.

4. The method of claim 3, further comprising:
comparing the user audio fingerprint with a plurality of advertisement fingerprints; and
retrieving the advertisement fingerprint that most closely corresponds to the user audio fingerprint.

5. The method of claim 1, wherein identifying the audio advertisement sample comprises:
generating text information based on the audio advertisement sample;
comparing the generated text information with a plurality of advertisement text information; and
retrieving the advertisement text information that most closely corresponds to the generated text information.

6. The method of claim 1, wherein identifying the audio advertisement sample comprises:
associating a user timestamp with the user-initiated telephone connection;
comparing the user timestamp with a plurality of broadcast timestamps; and
retrieving a broadcast timestamp that most closely corresponds to the user timestamp.

7. The method of claim 1, wherein identifying the audio advertisement sample comprises:
obtaining a preferred broadcast source based on a user preference;
associating a user timestamp with the user-initiated telephone connection;
comparing the user timestamp with a plurality of broadcast timestamps associated with the preferred broadcast source; and
retrieving a broadcast timestamp that most closely corresponds to the user timestamp.

8. The method of claim 1, wherein retrieving the metadata comprises:
determining whether the audio advertisement sample contains the metadata; and
generating the metadata, if the audio advertisement sample does not contain the metadata.

9. The method of claim 1, wherein obtaining a targeted advertisement information comprises:
comparing the metadata with a plurality of advertisements in an advertisement inventory database; and
obtaining an advertisement that most closely corresponds to the metadata.

10. The method of claim 1, wherein the broadcast source is one selected from a group of a radio station, a television station, an Internet website, an Internet service provider, a cable television station, a satellite radio station, a shopping mall, and a store.

11. The method of claim 1, wherein the message is one selected from a group of a text message, an e-mail message, a multimedia message, an audio message, a wireless application protocol message, and a data feed.

12. The method of claim 1, wherein the metadata is one selected from a group of a radio broadcast data standard (RBDS) broadcast stream, a radio data system (RDS) broadcast stream, a high definition radio broadcast stream, a vertical blanking interval (VBI) broadcast stream, a digital audio broadcasting (DAB) broadcast stream, a MediaFLO broadcast stream, and a closed caption broadcast stream.

13. The method of claim 3, wherein the telephone information comprises at least one selected from a group of an automatic number identifier (ANI), a carrier identifier (Carrier ID), a dialed number identification service (DNIS), an automatic location identification (ALI), and a base station number (BSN).

14. A system comprising:
a server;
a computer program product stored on one or more computer readable mediums, the computer program product including a first plurality of executable instructions configured to cause the server to perform operations comprising:
receiving a user-initiated telephone connection comprising an audio advertisement sample from a broadcast source;
identifying the audio advertisement sample;
retrieving a metadata associated with the identified audio advertisement sample;
obtaining a targeted advertisement information that most closely corresponds to the retrieved metadata; and
transmitting a message comprising the targeted advertisement information.

15. The system of claim 14, wherein the operation of identifying the audio advertisement sample comprises:
obtaining a user audio watermark of the audio advertisement sample;
comparing the user audio watermark with a plurality of advertisement watermarks; and
retrieving the advertisement watermark that most closely corresponds to the user audio watermark.

16. The system of claim 14, wherein the operation of identifying the audio advertisement sample comprises:
generating a user audio fingerprint of the audio advertisement sample;
associating a user audio timestamp with the user audio fingerprint; and
retrieving telephone information through the user-initiated telephone.

17. The system of claim 16, wherein the operation of identifying the audio advertisement sample further comprises:
comparing the user audio fingerprint with a plurality of advertisement fingerprints; and
retrieving the advertisement fingerprint that most closely corresponds to the user audio fingerprint.

18. The system of claim 14, wherein the operation of identifying the audio advertisement sample comprises:
generating text information based on the audio advertisement sample;
comparing the generated text information with a plurality of advertisement text information; and
retrieving the advertisement text information that most closely corresponds to the generated text information.

19. The system of claim 14, wherein the operation of identifying the audio advertisement sample comprises:
associating a user timestamp with the user-initiated telephone connection;
comparing the user timestamp with a plurality of broadcast timestamps; and
retrieving a broadcast timestamp that most closely corresponds to the user timestamp.

20. The system of claim 14, wherein the operation of identifying the audio advertisement sample comprises:
obtaining a preferred broadcast source based on a user preference;
associating a user timestamp with the user-initiated telephone connection;
comparing the user timestamp with a plurality of broadcast timestamps associated with the preferred broadcast source; and
retrieving a broadcast timestamp that most closely corresponds to the user timestamp.

21. The system of claim 14, wherein the operation of retrieving the metadata comprises:
determining whether the audio advertisement sample contains the metadata; and
generating the metadata if the audio advertisement sample does not contain the metadata.

22. The system of claim 14, wherein the operation of obtaining a targeted advertisement information that most closely corresponds to the retrieved metadata comprises:
comparing the metadata with a plurality of advertisements in an advertisement inventory database; and
retrieving an advertisement that most closely corresponds to the metadata.
